(19) United States
(12) Patent Application Publication
(10) Pub. No.: US 2022/0004233 A1
(43) Pub. Date: Jan. 6, 2022

(54) EXTERNAL EXPANSION DEVICE FOR MAINFRAME COMPUTER EXPANSION CARD

(71) Applicant: EDAC ELECTRONICS TECHNOLOGY (HANGZHOU) CO., LTD, HANGZHOU (CN)

(72) Inventor: CHANGZHONG FAN, HANGZHOU (CN)

(21) Appl. No.: 16/917,939

(22) Filed: Jul. 1, 2020

(51) Int. Cl. G06F 1/18

(52) U.S. Cl. CPC G06F 1/182

(57) ABSTRACT

An external expansion device for a mainframe computer expansion card, which includes: a L-shaped expansion rack and a data line for connecting with expansion card. The expansion rack is provided outside the mainframe computer chassis. The expansion rack includes a fixed part, and at least one expansion card plug part vertical to the fixed part. The one end of the data line for connecting with expansion card is electrically connected with the expansion card plug part, the other end of the expansion card plug part is used to connect with a motherboard inside the mainframe computer chassis. It does not need to remove the cover of the chassis during the demolition process, so that the purpose of dust-proof is achieved. It has a fast speed to add, remove, and replace the expansion card just in several seconds and is easy to operate without professional operation.

### TECHNICAL FIELD OF THE INVENTION

The disclosure relates to the field of mainframe computer chassis, especially an external expansion device for the mainframe computer expansion card.

### BACKGROUND OF THE INVENTION

In the prior art, if the mainframe computer chassis needs to add an internal expansion card, it must disassemble the chassis for adding, removing, and replacing the expansion card. The process of disassembling the chassis is complicated, because the process needs to use tools and is not easy to operate. For example, it needs to use a screwdriver to remove the cover, and turn over the chassis to remove the card, so that the process will take a long time which depends on the degree of proficiency and professionalism, furthermore, the demolition process inside the mainframe computer cannot be dustproof.

### SUMMARY OF THE INVENTION

The purpose of the disclosure is to provide an external expansion device for the mainframe computer expansion card, which is intended to solve at least one of problems raised in the background of the invention.

The disclosure provides an external expansion device for a mainframe computer expansion card including: a L-shaped expansion rack and a data line for connecting with expansion card; wherein, the expansion rack is provided outside the mainframe computer chassis, the expansion rack comprises a fixed part, and at least one expansion card plug part vertical to the fixed part; the one end of the data line for connecting with expansion card is electrically connected with the expansion card plug part, the other end of the expansion card plug part is used to connect with a motherboard inside the mainframe computer chassis.

Further, the expansion rack is connected with the outside of the mainframe computer chassis.

Further, the expansion rack is integratedly shaped with the mainframe computer chassis.

Further, the other end of the expansion card plug part is connected with the motherboard by an expansion card.

As a result of the above-mentioned technical solution, the disclosure can add, removing, and replace the expansion card outside the mainframe computer chassis without using any tools, removing the cover of the chassis, and turning over the chassis. Therefore, it does not need to remove the cover of the chassis during the demolition process, so that the purpose of dust-proof is achieved. Additionally, it has a fast speed to add, remove, and replace the expansion card just in several seconds and is easy to operate without the need of professional operation.

### BRIEF DESCRIPTION OF THE DRAWINGS

FIG. 1 shows a first structure diagram of the disclosure;

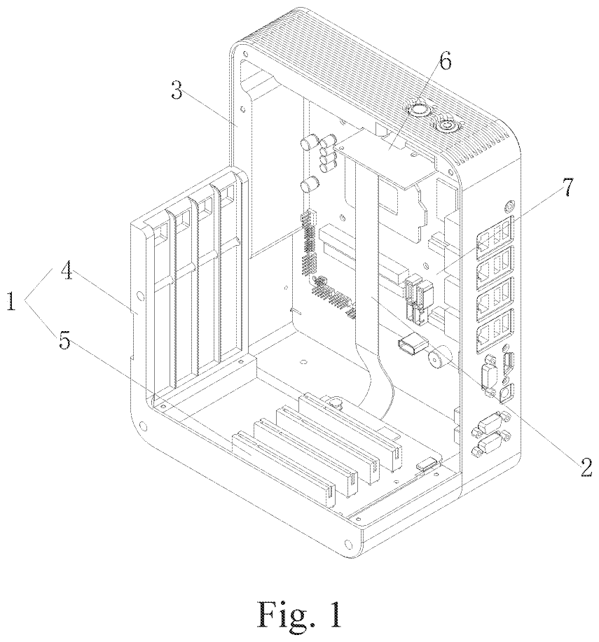

FIG. 2 shows a second structure diagram of the disclosure;

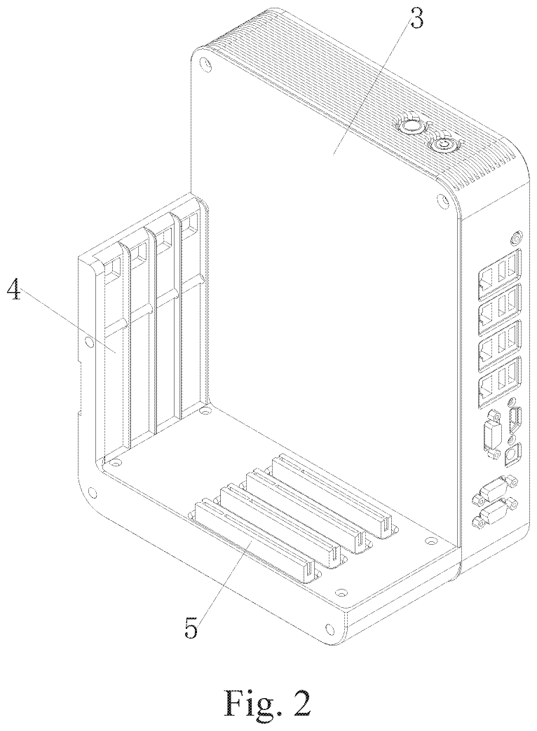

FIG. 3 shows a first using state diagram of the disclosure;

FIG. 4 shows a second using state diagram of the disclosure.

Reference Numerals: 1, expansion rack; 2, data line for connecting with expansion card; 3, mainframe computer chassis; 4, fixed part; 5, expansion card plug part; 6, expansion card; 7, motherboard; 8, external expansion card.

### DETAILED DESCRIPTION OF THE EMBODIMENTS

In order to make the purpose, technical solution and advantages of the disclosure more clearly, the disclosure, combined with drawings and embodiments, will be further detailed. It should be understood that the specific embodiments described herein are intended only to explain the disclosure and are not intended to qualify the disclosure.

As one aspect of the disclosure, it provides an external expansion device for a mainframe computer expansion card, which includes: a L-shaped expansion rack 1 and a data line 2 for connecting with expansion card. The expansion rack 1 is provided outside the mainframe computer chassis 3. The expansion rack 1 includes a fixed part 4, and at least one expansion card plug part 5 vertical to the fixed part 4. The one end of the data line 2 for connecting with expansion card is electrically connected with the expansion card plug part 5, the other end of the expansion card plug part 5 is used to connect with a motherboard 7 inside the mainframe computer chassis 3.

Preferably, the expansion rack 1 is connected with the outside of the mainframe computer chassis 3. Preferably, the expansion rack 1 is integratedly shaped with the mainframe computer chassis 3.

Preferably, the other end of the expansion card plug part 5 is connected with the motherboard 7 by an expansion card 6.

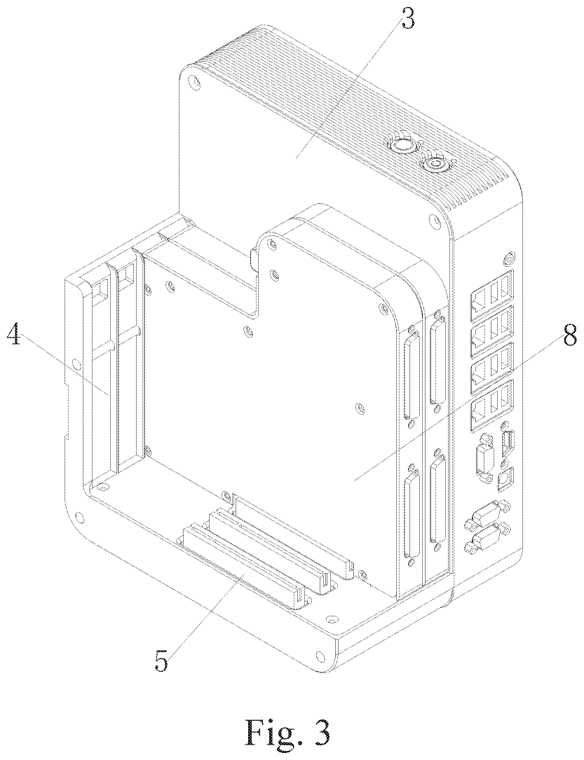

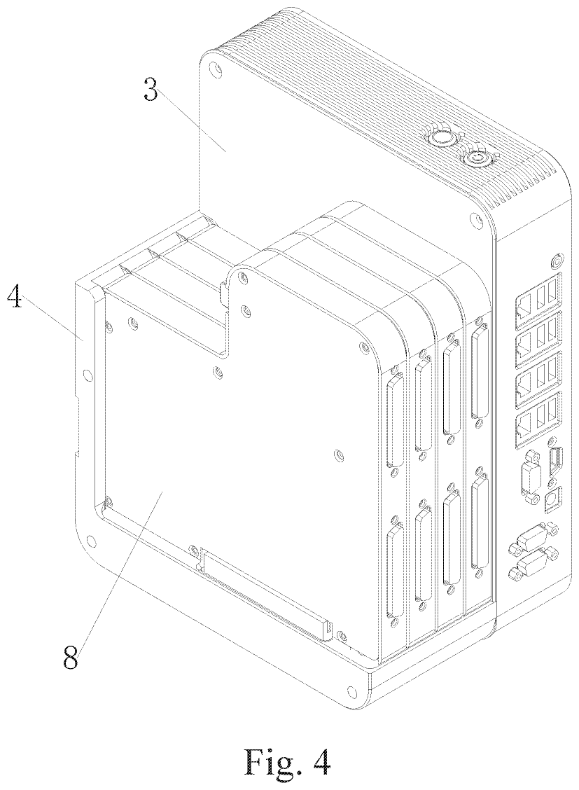

Please refer to FIG. 3 and FIG. 4, when using, firstly, connect the expansion rack 1 with the motherboard 7 inside the mainframe computer chassis 3 through the data line 2, and put the expansion rack 1 outside the mainframe computer chassis 3. Then, install the cover of the mainframe computer chassis 3 to seal the mainframe computer chassis 3. Next, insert the external expansion card 8 to be installed into expansion card plug part 5 of the expansion rack 1. Thus, the expansion card is installed completely.

As a result of the above-mentioned technical solution, the disclosure can add, removing, and replace the expansion card outside the mainframe computer chassis without using any tools, removing the cover of the chassis, and turning over the chassis. Therefore, it does not need to remove the cover of the chassis during the demolition process, so that the purpose of dust-proof is achieved. Additionally, it has a fast speed to add, remove, and replace the expansion card just in several seconds and is easy to operate without the need of professional operation.

The embodiments described above represent only a few embodiments of the disclosure, its description is more specific and detailed, but cannot be understood as a limitation on the scope of the patent of the disclosure. It should be pointed out that for ordinary technical personnel in the art, without departing from the concept of the disclosure, you can also make a number of deformations and improvements, these are the scope of protection of the disclosure. Therefore, the scope of protection of the patent of the disclosure shall be subject to the attached claim.

What is claimed is:

1. An external expansion device for a mainframe computer expansion card comprising: a L-shaped expansion rack and a data line for connecting with expansion card; wherein,
the expansion rack is provided outside the mainframe computer chassis, the expansion rack comprises a fixed part, and at least one expansion card plug part vertical to the fixed part;
the one end of the data line for connecting with expansion card is electrically connected with the expansion card plug part, the other end of the expansion card plug part is used to connect with a motherboard inside the mainframe computer chassis.

2. The external expansion device for a mainframe computer expansion card according to claim 1, wherein the expansion rack is connected with the outside of the mainframe computer chassis.

3. The external expansion device for a mainframe computer expansion card according to claim 1, wherein the expansion rack is integratedly shaped with the mainframe computer chassis.

4. The external expansion device for a mainframe computer expansion card according to claim 1, wherein the other end of the expansion card plug part is connected with the motherboard by an expansion card.
